(19) United States
(12) Patent Application Publication
(10) Pub. No.: US 2009/0019774 A1
(43) Pub. Date: Jan. 22, 2009

(54) Jalousie window

(76) Inventors: David Dezhou Zhao, Tacoma, WA (US); Kevin Dwayne Vilhauer, Puyallup, WA (US)

Correspondence Address: N. D. Parikh, Masco Corporation, 21001 Van Born Road, Taylor, MI, 48180, US

(21) Appl. No.: 11/880,064

(22) Filed: Jul. 19, 2007

(51) Int. Cl. E06B 7/08

(52) U.S. Cl. 49/74.1

(57) ABSTRACT

A jalousie window in accordance with an exemplary embodiment of the present disclosure includes a jalousie window insert having parallel side rails and a plurality of window louvers extending between the side rails for simultaneous rotation around parallel horizontal axes. A window frame includes a frame head, a frame sill, and a pair of spaced frame jambs interconnected with the frame head and sill in a rectangular frame geometry. A pair of opposed jamb adapters include outer portions secured by snap fit to the frame jambs and inner portions that receive by snap fit an associated one of the insert side rails such that the side rails and the jalousie window insert are secured by the jamb adapters within the window frame. A head adapter has an outer portion secured by snap fit to the frame head, and a sill adapter has an outer portion secured by snap fit to the frame sill. Weather seals are disposed on the head and sill adapters for engagement by upper and lower louvers of the window insert in closed positions of the louvers.

The present disclosure relates to a jalousie window that includes a jalousie window insert mounted by adapters within a window frame without use of fasteners or the like.

### BACKGROUND AND SUMMARY OF THE DISCLOSURE

The present disclosure embodies a number of aspects that can be implemented separately from or in combination with each other.

A jalousie window in accordance with an exemplary embodiment of the present disclosure includes a jalousie window insert having parallel side rails and a plurality of window louvers extending between the side rails for simultaneous rotation around parallel horizontal axes. A window frame includes a frame head, a frame sill, and a pair of spaced frame jambs interconnected with the frame head and sill in a rectangular frame geometry. A pair of opposed jamb adapters include outer portions secured by snap fit to the frame jambs and inner portions that receive by snap fit an associated one of the insert side rails such that the side rails and the jalousie window insert are secured by the jamb adapters within the window frame. A head adapter has an outer portion secured by snap fit to the frame head, and a sill adapter has an outer portion secured by snap fit to the frame sill. Weather seals are disposed on the head and sill adapters for engagement by upper and lower louvers of the window insert in closed positions of the louvers.

The jamb adapters, the sill adapter and the head adapter preferably are of extruded plastic or aluminum construction. The head and sill adapters preferably are identical, and the jamb adapters preferably are identical and mirror images of each other. The sill adapter preferably has an open water channel beneath a lower one of the louvers that drains into at least one aligned opening beneath one jalousie window insert side rail.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a perspective view of a jalousie window in accordance with an exemplary embodiment of the present disclosure;

FIGS. 2 and 3 are fragmentary sectional views taken substantially along the respective lines 2-2 and 3-3 in FIG. 1;

FIG. 4 is an enlarged view of the portion of FIG. 1 within the area 4;

FIG. 5 is an elevational view of the window of FIG. 1 with the louvers removed for clarity;

FIGS. 6 and 7 are sectional views taken substantially along the respective lines 6-6 and 7-7 in FIG. 5; and

FIGS. 8 and 9 are sectional views that illustrate exemplary weather seals.

### DETAILED DESCRIPTION OF PREFERRED EMBODIMENTS

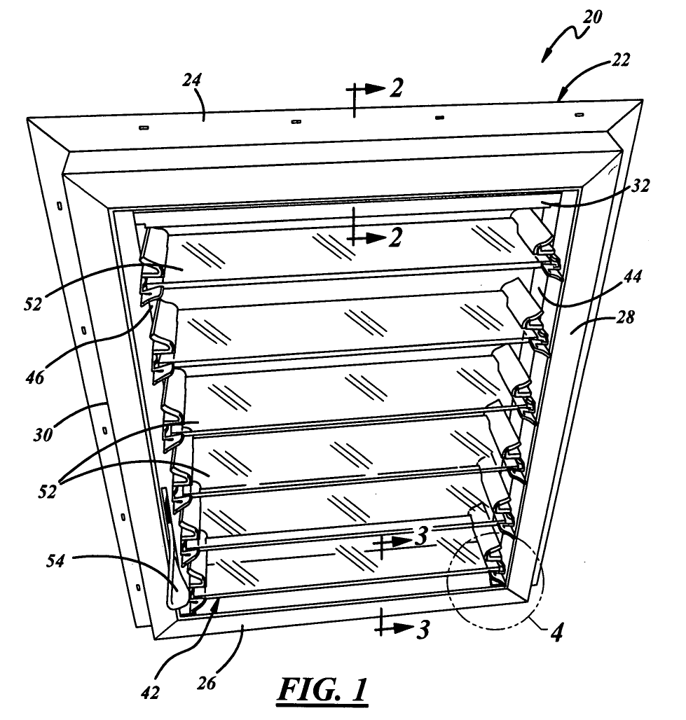

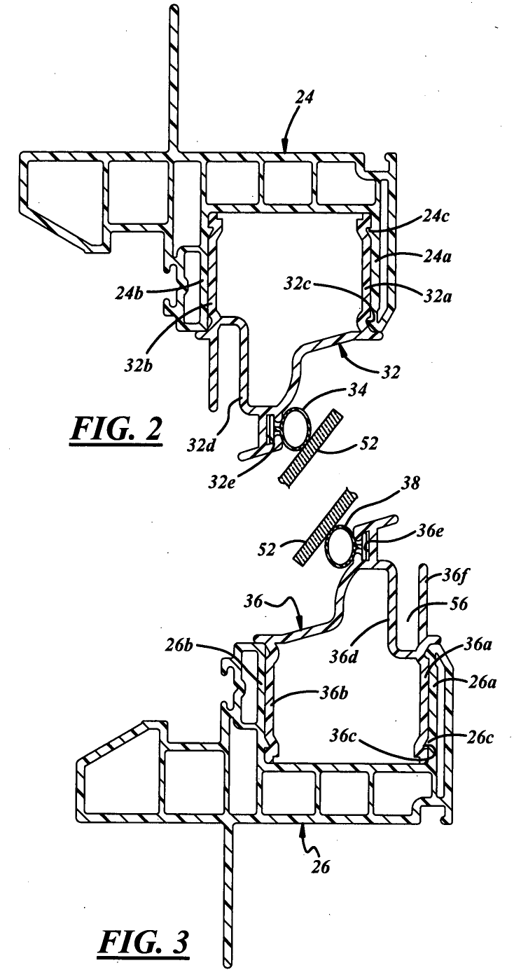

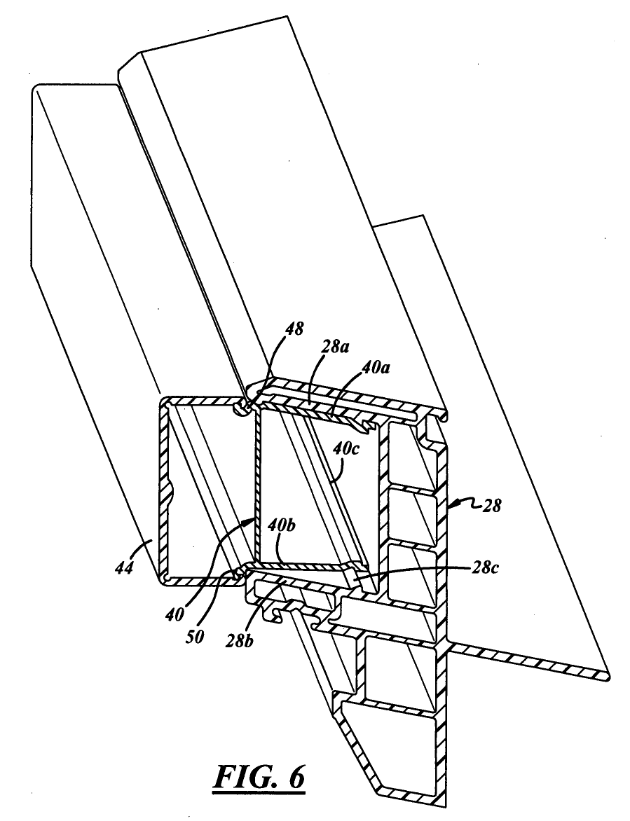

FIG. 1 illustrates a jalousie window 20 in accordance with an exemplary embodiment of the present disclosure. Window 20 includes a window frame 22 with a frame head 24, a frame sill 26, and a pair of laterally spaced frame jambs 28,30 interconnected in a rectangular frame geometry. Frame head 24, sill 26 and jambs 28,30 can be of any suitable cross sectional geometry for mounting window 20 on a building wall, with the geometries illustrated in the drawings being exemplary only. Frame head 24 has an inwardly opening U-shaped cross section defined in part by a pair of opposed walls 24a,24b (FIG. 2). Likewise, frame sill 26 has an inwardly opening U-shaped cross section defined in part by a pair of opposed walls 26a,26b (FIG. 3). Frame jamb 28 has an inwardly opening U-shaped cross section defined in part by a pair of opposed walls 28a,28b (FIG. 6). Frame jamb 30 is a mirror image of frame jamb 28. Frame head 24, sill 26 and jambs 28,30 can be of any suitable plastic or metal construction.

A head adapter 32 has an outer portion secured by snap fit to the inner edge of frame head 24. (Directional adjectives such as “inner” and “outer” are taken with reference to the center of window 20.) Head adapter 32 has a generally U-shaped cross section with legs 32a,32b (FIG. 2) respectively received by snap fit within walls 24a,24b of frame head 24. Barbs or beads 24c can be received within associated channels 32c to retain head adapter 32 in place. Head adapter 32 has an inwardly extending arm 32d with a laterally opening channel 32e that receives a weather seal 34. A sill adapter 36, which preferably is identical to head adapter 32, has a pair of legs 36a,36b that are received by snap fit within walls 26a,26b of frame sill 26. Again, sill adapter 36 preferably is received by snap fit within sill 26 and retained by suitable barbs or beads 26c being received within corresponding channels 36c of sill adapter 36. A leg 36d of sill adapter 36 extends inwardly and has a laterally opening channel 36e that receives a weather seal 38. It will be noted in FIGS. 2 and 3 that legs 32d, 36d are such that weather seal 34 faces the interior of the building to which window 20 is assembled while weather seal 38 faces the exterior.

Frame jambs 28,30 have opposed inwardly opening U-shaped cross-sections that each receive a jamb adapter 40 (FIG. 6). Jamb adapters 40 associated with frame jambs 28,30 are identical and mirror images of each other, with the jamb adapter associated with frame jamb 28 being shown in detail in FIG. 6. Jamb adapter 40 is of generally U-shaped cross section with opposed legs 40a,40b that are received within walls 28a,28b of frame jamb 28 and secured by snap fit, such as by barbs or beads 28c being received within channels 40c. Head adapter 32, sill adapter 36 and jamb adapters 40 preferably are of extruded plastic or aluminum construction.

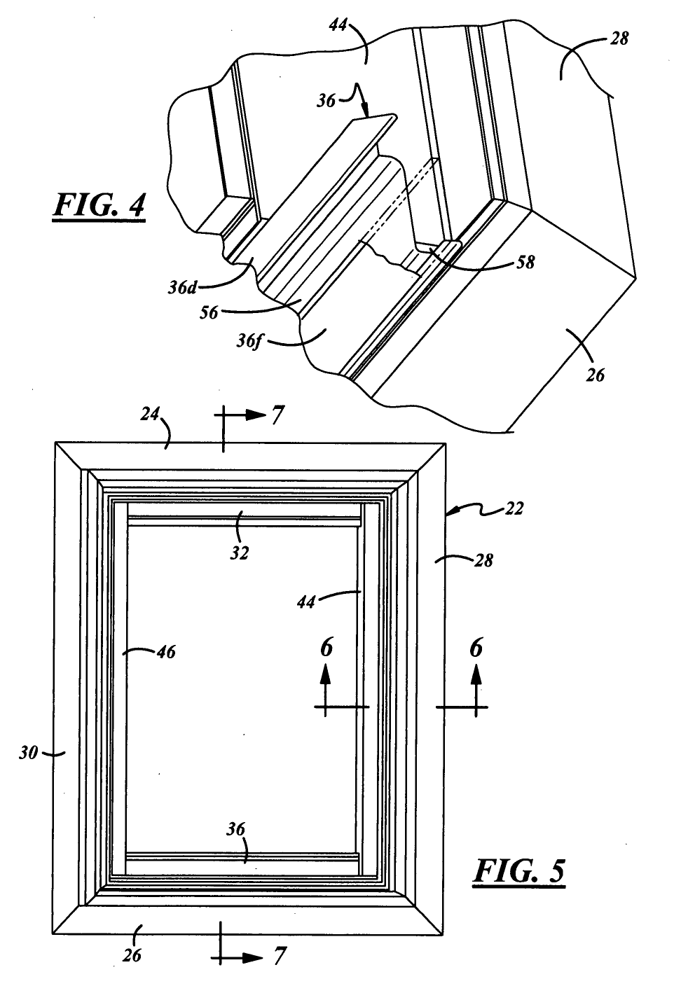

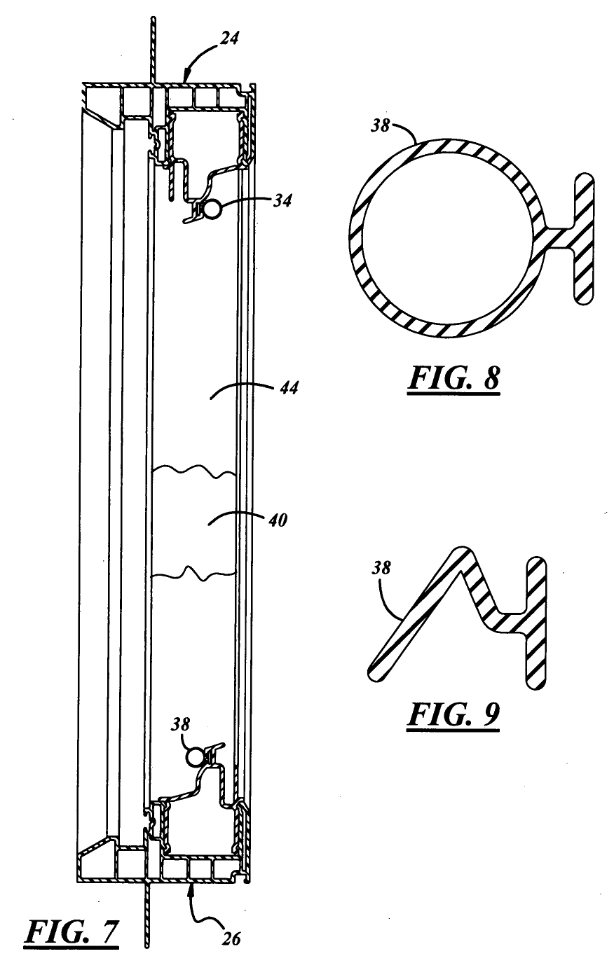

A jalousie window insert 42 has parallel side rails 44,46 that are respectively received by snap fit over inwardly extending legs 48,50 (FIG. 6) on the opposed jamb adapters 40 to secure jalousie window insert 42 in place within frame 22. Window insert 42 preferably also includes a plurality of spaced window louvers 52 that extend between side rails 44,46 for simultaneous rotation around parallel horizontal axes. Louvers 52 can be rotated by a handle 54 as illustrated in FIG. 1, or by suitable cranks or levers. Window insert 42 typically is purchased as a subassembly from a supplier, and the internal details of the insert are not part of the present disclosure. In the closed positions of louvers 52, the upper louver contacts and compresses weather seal 34 on head adapter 32 (FIG. 2) while the lower louver 52 engages and compresses weather seal 38 on sill adapter 36. Weather seals 34,38 can be of any suitable resilient construction, with two exemplary constructions being illustrated in FIGS. 8 and 9. It also will be noted in FIGS. 4-5 and 7 that, whereas head and sill adapters 32,36 are visible within frame 22, jamb adapters 40 preferably are concealed beneath jalousie window insert side rails 44.

Sill adapter 36 preferably includes a longitudinally extending flange or wall 36f (FIGS. 3 and 4) that forms a water channel 56 adjacent to and beneath the interior side of the lowest louver 52. Water channel 56 communicates with an opening 58 beneath the lower edge of jalousie window insert side rail 44 so that any water collected in channel 56 can drain through opening 58 and thence through appropriate weep openings to the exterior of the building. There preferably are openings 58 at both ends of sill adapter 36.

There thus has been disclosed a jalousie window that includes a jalousie window insert mounted by adapters within a window frame. The disclosure has been presented in conjunction with an exemplary embodiment, and modifications and variations have been discussed. Other modifications and variations readily will suggest themselves to persons of ordinary skill in the art in view of the foregoing description. The disclosure is intended to embrace all such modifications and variations as fall within the spirit and broad scope of the appended claims.

1. A jalousie window that includes:
a jalousie window insert having parallel side rails and a plurality of window louvers extending between said side rails for simultaneous rotation around parallel horizontal axes,
a window frame including a frame head, a frame sill, and a pair of spaced frame jambs interconnected with said frame head and said frame sill in a rectangular frame geometry,
a pair of opposed jamb adapters, each of which includes an outer portion secured by snap fit to an associated one of said frame jambs and an inner portion that receives by snap fit one of said side rails such that said side rails and said jalousie window insert are secured by said jamb adapters within said window frame,
a head adapter having an outer portion secured by snap fit to said frame head,
a sill adapter having an outer portion secured by snap fit to said frame sill, and
weather seals on said head and sill adapters for engagement by upper and lower louvers of said jalousie window insert in closed positions of said louvers.

2. The window set forth in claim 1 wherein said jamb adapters, said head adapter and said sill adapter are of extruded plastic or aluminum construction.

3. The window set forth in claim 2 wherein said frame head, said frame sill and said frame jambs have inwardly opening U-shaped channels, and wherein said outer portions of said head adapter, said sill adapter and said jamb adapters are of U-shaped cross section with opposed legs that are received by snap fit within said U-shaped channels.

4. The window set forth in claim 3 wherein said head and sill adapters have inner portions with channels in which said weather seals are disposed.

5. The window set forth in claim 4 wherein said inner portions of said jamb adapters have legs that receive outer edges of said rails.

6. The window set forth in claim 2 wherein said head and sill adapters are identical.

7. The window set forth in claim 6 wherein said jamb adapters are identical and mirror images of each other.

8. The window set forth in claim 1 wherein said sill adapter has an open water channel beneath a lower one of said louvers.

9. The window set forth in claim 8 wherein at least one of said jamb adapters has a lower edge that forms an opening that registers in assembly with said water channel to drain water from within said water channel.

10. The window set forth in claim 9 wherein said window frame is adapted to mount said window on a building wall such that one side of said window is on an interior side of said wall, and wherein said open water channel is on said one side of said window.
